(19) United States
(12) Patent Application Publication
(10) Pub. No.: US 2009/0170022 A1
(43) Pub. Date: Jul. 2, 2009

(54) ELECTROPHOTOGRAPHIC DEVELOPER CARRIER AND ELECTROPHOTOGRAPHIC DEVELOPER USING THE SAME CARRIER

(75) Inventors: Takashi KOJIMA, Kashiwa-shi (JP); Tetsuya UEMURA, Kashiwa-shi (JP); Tsuyoshi ITAGOSHI, Matsudoshi (JP)

Correspondence Address: GREENBLUM & BERNSTEIN, P.L.C., 1950 ROLAND CLARKE PLACE, RESTON, VA, 20191, US

(73) Assignee: POWDERTECH CO., LTD., Chiba (JP)

(21) Appl. No.: 12/342,459

(22) Filed: Dec. 23, 2008

(30) Foreign Application Priority Data
Dec. 28, 2007 (JP) 2007-340620
Oct. 16, 2008 (JP) 2008-267113

(51) Int. Cl. G03G 9/10

(52) U.S. Cl. 430/111.1

(57) ABSTRACT

There are adopted: an electrophotographic developer carrier that includes on the surface of a carrier core material a coating resin including a silicone resin containing a fluorine silane coupling agent, has an intensity ratio (F/Si), measured with fluorescent X-ray, between the fluorine atom and the silicon atom present on the carrier surface of 1.4×10⁻³ to 2.0×10⁻³, and has an intensity ratio (F/Fe), measured with fluorescent X-ray, between the fluorine atom and the iron atom present on the carrier surface of 2.3×10⁻⁵ to 3.5×10⁻⁵; and an electrophotographic developer using the carrier.

### BACKGROUND OF THE INVENTION

1. Field of the Invention

The present invention relates to an electrophotographic developer carrier which is used in a two-component electrophotographic developer used in apparatuses such as copying machines and printers, and an electrophotographic developer using the carrier.

2. Description of the Related Art

In an electrophotographic development method, carrier particles are required to triboelectrically charge toner particles with a desired polarity and a sufficient charge amount always during the use of the carrier for a long time. However, the collision between the carrier particles, the mechanical stirring in a developer box or the heat generation by the collision or the stirring causes the so-called spent condition of the carrier in which the toner is fusion bonded to the surface of the carrier particles, and hence the charging capability of the carrier particles is degraded with elapsed operating time. Accordingly, image quality degradation such as fogging or toner scattering occurs, and hence the whole developer comes to need to be replaced.

For the purpose of preventing the occurrence of the spent condition, it has hitherto been attempted to extend the operating life of the carrier by coating the surface of the carrier core material with a resin which is low in surface energy such as fluororesin or silicone resin.

For example, in Japanese Patent Laid-Open No. 2002-23429, for the purpose of providing a two-component developer which is high in developing ability even in rapid performing of development and small in developing ability degradation even in performing long term image formation, there has been proposed a carrier prepared by coating the surface of a magnetic particle with a resin which contains a conductive carbon and a crosslinked fluorine-modified silicone resin wherein the average particle size of the magnetic particle is 30 to 90 μm, and the aggregation proportion of the carrier is 2 to 15%.

In Japanese Patent Laid-Open No. 61-110161, for the purpose of providing a negatively charged carrier which is excellent in triboelectric charging capability and is hardly exfoliated, there has been proposed a carrier having a coating layer which contains a silicon varnish and a perfluoroalkylsilane coupling agent.

Additionally, for the purpose of providing a carrier excellent in reliability such that the carrier is small in the proportion of the spent carrier even in a long time use, does not cause the decrease of the charge amount, the toner scattering and the background staining, and can maintain a stable high image quality low in carrier adhesion, and also for the purpose of providing a developer and a development method, there has been proposed a carrier, in Japanese Patent Laid-Open No. 2003-280286, which has a weight average particle size Dw of 25 to 45 μm, has a proportion of the particles smaller than 44 μm in particle size of 70% by weight or more, has a proportion of the particles smaller in particle size of 22 μm of 7.0% by weight or less, and is coated with a silicone resin which contains a fluorine-containing silane coupling agent and a composition having positive charging capability; and there has been proposed a carrier, in Japanese Patent Laid-Open No. 2003-280289, in which the surface of a magnetic core material is coated with a coating film that contains a silicone resin, an aminosilane coupling agent and a fluorine-containing silane coupling agent.

Further, in Japanese Patent Laid-Open No. 2003-280290, for the purpose of providing an electrophotographic carrier for a highly durable two-component developer, an electrophotographic carrier for a highly durable two-component developer even in combination with a toner that contains a release agent, an electrophotographic developer, an electrophotographic image formation method and an electrophotographic image formation apparatus, there has been proposed a carrier in which the particle size (D) and a binder resin film thickness (h) satisfy the relation 1<[D/h]<10, and the particles and/or the coating film is subjected to a surface treatment with a single or two or more substances selected from among a titanate coupling agent, a fluorine-containing silane coupling agent and acetoalkoxy aluminum diisopropylate.

However, the above-described conventional technology can only insufficiently attain the extension of the operating life of the carrier in relation to the changes, in items such as toners and image formation apparatuses such as copying machines, accompanying the recent demand for attaining high image quality.

In these years, for the purpose of achieving high image quality, toners have tended to be made smaller in particle size, and accordingly, for the purpose of improving the accompanying degradation of the fluidity or the charging capability, oxides such as silica and titania are externally added to toners. Herewith, the toner spent on the carrier is made to occur more easily. In particular, in the case of a full-color toner, for the purpose of upgrading the color reproducibility, low softening point resins are used. Further, in the case of a developer where the toner is made to contain a wax to facilitate the maintenance thereof, the amount of the toner spent on the carrier is extremely increased, and the charge amount decrease of the toner, fogging and toner scattering tend to occur more easily. In a full-color electrophotographic system, when the charge amount is decreased, the image density in the highlight portion tends to vary more easily, and hence, as affairs stand, no high image quality can be maintained.

Further miniaturization and power saving of image formation apparatuses such as copying machines are demanded, and accordingly miniaturization or power saving of the members such as photoreceptors and developer boxes have been investigated. Among such members, fixing units are particularly attracting attention. In a conventional fixing unit, application of an oil such as silicone oil is adopted for the purpose of preventing the offset between the fixing roller and the recording paper. For this purpose, an oil tank and an oil coating device are required, and hence the miniaturization of the fixing unit is found to be a difficulty. For the purpose of solving such a difficulty, it has been investigated to include in the toner a release agent to prevent offset. However, a release agent-containing toner suffers from a problem that the release agent tends to adhere to the carrier surface and the operating life of such a toner as a developer is short; thus, also in combination with a release agent-containing toner, the demand for a carrier having a high durability is significant.

As described above, there have been demanded: an electrophotographic developer carrier which, even in a long term use, prevents the occurrence of the spent condition, is small in the degradation of the charge amount, is excellent in durability, is low in the toner scattering and is satisfactory in the image density; and an electrophotographic developer using the electrophotographic developer carrier.

### SUMMARY OF THE INVENTION

Accordingly, the present invention takes as its object the provision of: an electrophotographic developer carrier which solves the above-described conventional problems, and even in a long term use in the image formation by means of an electrophotographic method, prevents the occurrence of the spent condition of the carrier, is small in the degradation of the charge amount, is excellent in durability, is low in the toner scattering and is satisfactory in the image density; and an electrophotographic developer using the electrophotographic developer carrier.

The present inventors reached the present invention by discovering, as the results of an investigation, that the above-described problems can be solved by an electrophotographic developer carrier in which a silicone resin is used as the coating resin, a fluorine silane coupling agent is contained in the resin, the intensity ratio, measured with fluorescent X-ray, between the fluorine atom and the silicon atom present on the carrier surface falls in a specified range, and the intensity ratio, measured with fluorescent X-ray, between the fluorine atom and the iron atom present on the carrier surface also falls in another specified range.

Specifically, the present invention provides an electrophotographic developer carrier that includes on the surface of a carrier core material a coating resin including a silicone resin containing a fluorine silane coupling agent, has an intensity ratio (F/Si), measured with fluorescent X-ray, between the fluorine atom and the silicon atom present on the carrier surface of 1.4×10⁻³ to 2.0×10⁻³, and has an intensity ratio (F/Fe), measured with fluorescent X-ray, between the fluorine atom and the iron atom present on the carrier surface of 2.3×10⁻⁵ to 3.5×10⁻⁵.

The electrophotographic developer carrier of the present invention is preferably such that the fluorine ratio represented by the molecular weight of the fluorine in the fluorine silane coupling agent/the molecular weight of the fluorine silane coupling agent is 0.49 or less.

The electrophotographic developer carrier of the present invention is preferably such that the content of the fluorine silane coupling agent in the coating resin in relation to the coating resin amount is 0.8 to 12.0% by weight.

Additionally, the present invention provides an electrophotographic developer including the carrier and a toner.

According to the present invention, there are obtained: an electrophotographic developer carrier which, even in a long term use, prevents the occurrence of the spent condition, is small in the degradation of the charge amount, is excellent in durability, is low in the toner scattering and is satisfactory in the image density; and an electrophotographic developer using the electrophotographic developer carrier.

### DETAILED DESCRIPTION OF THE PREFERRED EMBODIMENTS

Hereinafter, the best mode for carrying out the present invention is described.

The electrophotographic developer carrier according to the present invention has on the surface of a carrier core material a coating resin including a silicone resin containing a fluorine silane coupling agent.

Examples of the carrier core material used in the electrophotographic developer carrier according to the present invention include iron powder core materials, magnetite core materials, resin carrier core materials and ferrite core materials which have hitherto been used as the electrophotographic developer carriers. Particularly preferable among these are ferrite core materials each containing at least one element selected from Mn, Mg, Li, Ca, Sr and Ti. In consideration of the recent trend of the environmental load reduction including the waste regulation, it is preferable not to include the heavy metals Cu, Zn and Ni each in a content exceeding an inevitable impurity range (associated impurity range).

The average particle size of the carrier core material is preferably 20 to 70 μm, and this range results in the prevention of the carrier adhesion and the provision of a satisfactory image quality. When the average particle size is less than 20 μm, unpreferably the carrier adhesion tends to occur. When the average particle size exceeds 70 μm, unpreferably the image quality tends to be deteriorated.

### (Average Particle Size)

The average particle size is measured with Microtrac Particle Size Analyzer (model 9320-X100) manufactured by Nikkiso Co., Ltd. Water is used as a dispersion medium. In a 100-ml beaker, 10 g of a sample and 80 ml of water are placed, and a few drops of a dispersant (sodium hexametaphosphate) are added in the beaker. Next, the mixture thus obtained is subjected to dispersion for 20 seconds with an ultrasonic homogenizer (model UH-150, manufactured by SMT Co., Ltd.) set at an output power level of 4. Thereafter, the foam formed on the surface of the dispersed mixture is removed and the dispersed mixture is placed in the measurement apparatus.

The magnetization of the carrier core material is preferably 60 to 95 Am²/kg at a magnetic field of 3,000×10³/4 π·A/m, and this range results in the prevention of the carrier adhesion and the provision of a satisfactory image quality.

### (Magnetization)

The magnetization is measured with an integral-type B-H tracer, model BHU-60 (manufactured by Riken Denshi Co., Ltd.). An H coil for measuring magnetic field and a 4 πI coil for measuring magnetization are inserted between the electromagnets. In this case, a sample is placed in the 4 πI coil. By integrating each of the outputs from the H coil and the 4 πI coil while the magnetic field H is being varied by varying the current of the electromagnet, a hysteresis loop is depicted on a sheet of recording paper with the H output on the X-axis and the 4 πI coil output on the Y-axis. Here, the measurement conditions are as follows: the sample filling quantity: approximately 1 g; the sample filling cell: inner diameter: 7 mmφ±0.02 mm and height: 10 mm±0.1 mm; 4 πI coil: 30 turns.

The electrophotographic developer carrier according to the present invention uses as a coating resin a silicone resin as described above.

The resin coating amount is preferably 0.5 to 3.0% by weight in relation to the carrier core material. When the resin coating amount is less than 0.5% by weight, the original functions of the coating resin against the occurrence of the spent condition and against the degradation of the charge amount cannot be exploited. When the resin coating amount exceeds 3.0% by weight, the mutual association of the carrier particles through the intermediary of the coating resin tends to occur, and thus, the occurrence of the spent condition is possibly promoted.

In the electrophotographic developer carrier according to the present invention, the intensity ratio (F/Si), measured with fluorescent X-ray, between the fluorine atom and the silicon atom present on the carrier surface is 1.4×10⁻³ to 2.0×10⁻³, and the intensity ratio (F/Fe), measured with fluorescent X-ray, between the fluorine atom and the iron atom present on the carrier surface is 2.3×10⁻⁵ to 3.5×10⁻⁵.

The intensity ratio (F/Si) between the fluorine atom and the silicon atom and the intensity ratio (F/Fe) between the fluorine atom and the iron atom, as referred to in the present invention, are derived through the following formulas, respectively:

F/Si=[fluorine atom X-ray intensity]/[silicon atom X-ray intensity]

F/Fe=[fluorine atom X-ray intensity]/[iron atom X-ray intensity]

Here, the “fluorine atom intensity,” “silicon atom intensity” and “iron atom intensity” can be measured with a fluorescent X-ray analyzer, model ZSX 100e (manufactured by Rigaku Corp.) by using the EZ scan that is a function of scanning the contained elements. Specifically, first, a measurement sample undergoes a treatment such that the carrier is uniformly adhered to a seal prepared by applying an adhesive to a polyester film. This seal is set on a measurement sample base, and can be measured under the following conditions (measurement range: F-U, measurement diameter: 30 mm, sample form: metal, measurement time: long, atmosphere: vacuum).

In the present invention, the intensity ratio (F/Si), measured with fluorescent X-ray, between the fluorine atom and the silicon atom present on the carrier surface is 1.4×10⁻³ to 2.0×10⁻³ as described above, and is more preferably 1.5×10⁻³ to 1.9×10⁻³. By setting the intensity ratio within the above-specified ranges, the occurrence of the spent condition is prevented and degradation of the charge amount is small even in a long term use. When the intensity ratio exceeds 2.0×10⁻³, the charge amount rise is aggravated and the change rate of the rise is made small. Additionally, when the intensity ratio is less than 1.4×10⁻³, the charging ability is remarkably degraded, and the decrease of the charge amount occurs in the course of the use of the carrier in an image formation apparatus such as a copying machine.

In the present invention, the intensity ratio (F/Fe), measured with fluorescent X-ray, between the fluorine atom and the iron atom present on the carrier surface is 2.3×10⁻⁵ to 3.5×10⁻⁵ as described above, and is more preferably 2.4×10⁻⁵ to 3.2×10⁻⁵. By setting the intensity ratio within the above-specified ranges, the occurrence of the spent condition is prevented and degradation of the charge amount is small even in a long term use. When the intensity ratio is less than 2.3×10⁻⁵, the occurrence of the spent condition is enhanced and the charge amount is decreased in the course of the use of the carrier when the carrier is used in an image formation apparatus such as a copying machine. Additionally, when the intensity ratio exceeds 3.5×10⁻⁵, the degradation of the image density, fogging or toner scattering tends to occur when the carrier is used in an image formation apparatus such as a copying machine.

In the present invention, the coating resin contains a fluorine silane coupling agent.

As the fluorine silane coupling agent used herein, the fluorine silane coupling agents represented by the following formula are preferable.

CₙF₂ₙ₊₁—(CH₂)ₘ—Si(R)₃ General formula

In the above formula, n represents an integer of 1 to 10; m represents an integer of 1 to 5; R represents an alkoxy group having 1 to 5 carbon atoms or a halogen atom; additionally, n is preferably 4 to 10, m is preferably 1 to 3, and R is preferably a methoxy group, an ethoxy group or a chlorine atom.

Specific examples of the fluorine-containing silane coupling agent may include: CF₃CH₂CH₂Si(OCH₃)₃, C₄F₉CH₂CH₂Si(OCH₃)₃, C₈F₁₇CH₂CH₂Si(OCH₃)₃, C₇F₁₅COOCH₂CH₂CH₂Si(OCH₃)₃, C₇F₁₅COSCH₂CH₂CH₂Si(OCH₃)₃, C₇F₁₅CONHCH₂CH₂CH₂Si(OC₂H₅)₃, C₇F₁₅CONHCH₂CH₂CH₂Si(OCH₃)₃, C₈F₁₇SO₂NHCH₂CH₂CH₂Si(OC₂H₅)₃, C₈F₁₇CH₂CH₂SCH₂CH₂Si(OCH₃)₃, C₁₀F₂₁CH₂CH₂SCH₂CH₂Si(OCH₃)₃, C₈F₁₇CH₂CH₂SiCH₃(OCH₃)₂, C₈F₁₇SO₂N(CH₂CH₂CH₃)CH₂CH₂CH₂Si(OCH₃)₃, and C₈F₁₇SO₂NHCH₂CH₂N(SO₂C₈F₁₇)CH₂CH₂CH₂Si(OCH₃)₃.

The fluorine ratio of the fluorine silane coupling agent is preferably 0.49 or less, and particularly preferably 0.46 or less. Here, the fluorine ratio is derived from the molecular weight of the fluorine silane coupling agent as the ratio represented by the molecular weight of the fluorine in the fluorine silane coupling agent/the molecular weight of the fluorine silane coupling agent. The fluorine ratio exceeding 0.49 results in inhibition of the hydrolysis of the silane coupling agent, unsuccessful incorporation of the silane coupling agent into the coating resin, or insufficient formation of the coating resin due to the steric hindrance of the silane coupling agent; thus, the abrasion or detachment of the coating resin layer tends to occur, and consequently, the operating life of the carrier is decreased when the carrier is used in an image formation apparatus such as a copying machine.

Examples of the fluorine silane coupling agent having a fluorine ratio of 0.49 or less may include: CF₃CH₂CH₂Si(OCH₃)₃, C₄F₉CH₂CH₂Si(OCH₃)₃, C₇F₁₅COOCH₂CH₂CH₂Si(OCH₃)₃, C₇F₁₅COSCH₂CH₂CH₂Si(OCH₃)₃, C₇F₁₅CONHCH₂CH₂CH₂Si(OC₂H₅)₃, C₈F₁₇SO₂NHCH₂CH₂CH₂Si(OCH₃)₃, and C₈F₁₇SO₂N(CH₂CH₂CH₃)CH₂CH₂CH₂Si(OCH₃)₃; and further, examples of the fluorine silane coupling agent having a fluorine ratio of 0.46 or less may include: CF₃CH₂CH₂Si(OCH₃)₃, C₄F₉CH₂CH₂Si(OCH₃)₃, and C₈F₁₇SO₂N(CH₂CH₂CH₃)CH₂CH₂CH₂Si(OCH₃)₃.

The content of the fluorine silane coupling agent is preferably 0.8 to 12.0% by weight and more preferably 1.0 to 10.0% by weight in relation to the coating resin. When the content of the fluorine silane coupling agent in relation to the coating resin is less than 0.8% by weight, no advantageous effects on the occurrence of the spent condition and the degradation of the charge amount are achieved, the charge amount is decreased and the durability of the carrier is aggravated. When the content of the fluorine silane coupling agent in relation to the coating resin exceeds 12.0% by weight, the steric hindrance of the fluorine silane coupling agent causes no sufficient formation of the coating resin; thus, the abrasion or detachment of the coating resin layer tends to occur, and consequently, the operating life of the carrier is decreased when the carrier is used in an image formation apparatus such as a copying machine.

Additionally, for the purpose of controlling the electric resistance, charge amount and charging rate of the carrier, a conductive agent can be added in the silicone resin used as the coating resin. The electric resistance of the conductive agent itself is low, and hence when the addition amount of the conductive agent is too large, a rapid charge leakage tends to occur. Accordingly, the addition amount of the conductive agent is 0.25 to 20.0% by weight, preferably 0.5 to 15.0% by weight and particularly preferably 1.0 to 10.0% by weight in relation to the solid content of the coating resin. Examples of the conductive agent include conductive carbon, oxides such as titanium oxide and tin oxide, and various organic conductive agents.

Further, a charge controlling agent can be contained in the coating resin. Examples of the charge controlling agent include various types of charge controlling agents and silane coupling agents generally used in toners. This is because in a case where the carrier is coated with a large amount of a resin, the charge imparting ability is degraded as the case may be, but the addition of various types of charge controlling agents and silane coupling agents enables the control of the degradation of the charge imparting ability. No particular constraint is imposed on the usable various types of charge controlling agents and silane coupling agent; preferable examples of the usable charge controlling agents and silane coupling agents include: charge controlling agents such as nigrosine dyes, quaternary ammonium salts, organometallic complexes and metal-containing monoazo dyes; and aminosilane coupling agents.

### <Electrophotographic Developer According to the Present Invention>

Next, description is made on the electrophotographic developer according to the present invention.

The electrophotographic developer according to the present invention is composed of the above-described electrophotographic developer carrier and a toner.

Examples of the toner particle constituting the electrophotographic developer of the present invention include a pulverized toner particle produced by a pulverization method and a polymerized toner particle produced by a polymerization method. In the present invention, the toner particle obtained by either of these methods can be used.

The pulverized toner particle can be obtained, for example, by means of a method in which a binder resin, a charge controlling agent and a colorant are fully mixed together with a mixing machine such as a Henschel mixer, then the mixture thus obtained is melt kneaded with an apparatus such as a double screw extruder, and the melt-kneaded substance is cooled, pulverized and classified, added with an external additive, and thereafter mixed with a mixing machine such as a mixer to yield the pulverized toner particle.

No particular constraint is imposed on the binder resin constituting the pulverized toner particle. However, examples of the binder resin may include polystyrene, chloropolystyrene, styrene-chlorostyrene copolymer, styrene-acrylate copolymer and styrene-methacrylic acid copolymer, and further, rosin-modified maleic acid resin, epoxy resin, polyester resin and polyurethane resin. These binder resins are used each alone or as mixtures thereof.

As the charge controlling agent, any charge controlling agent can be used. Examples of the charge controlling agent for use in positively charged toners may include nigrosine dyes and quaternary ammonium salts. Additionally, examples of the charge controlling agent for use in negatively charged toners may include metal-containing monoazo dyes.

As the colorant (coloring material), hitherto known dyes and pigments can be used. Examples of the usable colorant include carbon black, phthalocyanine blue, permanent red, chrome yellow and phthalocyanine green. Additionally, for the purpose of improving the fluidity and the anti-aggregation property of the toner, external additives such as a silica powder and titania can be added to the toner particle according to the toner particle.

The polymerized toner particle is a toner particle produced by heretofore known methods such as a suspension polymerization method, an emulsion polymerization method, an emulsion aggregation method, an ester extension polymerization method and a phase inversion emulsion method. Such a polymerized toner particle can be obtained, for example, as follows: a colorant dispersion liquid in which a colorant is dispersed in water with a surfactant, a polymerizable monomer, a surfactant and a polymerization initiator are mixed together in a aqueous medium under stirring to disperse the polymerizable monomer by emulsification in the aqueous medium; the polymerizable monomer thus dispersed is polymerized under stirring for mixing; thereafter, the polymer particles are salted out by adding a salting-out agent; the particles obtained by salting-out is filtered off, rinsed and dried, and thus the polymerized toner particle can be obtained. Thereafter, according to need, an external additive is added to the dried toner particle.

Further, when the polymerized toner particle is produced, in addition to the polymerizable monomer, the surfactant, the polymerization initiator and the colorant, a fixability improving agent and a charge controlling agent can also be mixed; the various properties of the obtained polymerized toner particle can be controlled and improved by these agents. Additionally, a chain transfer agent can also be used for the purpose of improving the dispersibility of the polymerizable monomer in the aqueous medium and regulating the molecular weight of the obtained polymer.

No particular constraint is imposed on the polymerizable monomer used in the production of the polymerized toner particle: however, example of such a polymerizable monomer may include: styrene and the derivatives thereof; ethylenically unsaturated monoolefins such as ethylene and propylene; vinyl halides such as vinyl chloride; vinyl esters such as vinyl acetate; and α-methylene aliphatic monocarboxylic acid esters such as methyl acrylate, ethyl acrylate, methyl methacrylate, ethyl methacrylate, 2-ethylhexyl methacrylate, acrylic acid dimethylamino ester and methacrylic acid diethylamino ester.

As the colorant (coloring material) used when the polymerized toner particle is prepared, hitherto known dyes and pigments can be used. Examples of the usable colorant include carbon black, phthalocyanine blue, permanent red, chrome yellow and phthalocyanine green. Additionally, the surface of each of these colorants may be modified by using silane coupling agents or titanium coupling agents.

As the surfactant used in the production of the polymerized toner particle, anionic surfactants, cationic surfactants, amphoteric surfactants and nonionic surfactants can be used.

Here, examples of the anionic surfactants may include: fatty acid salts such as sodium oleate and castor oil; alkyl sulfates such as sodium lauryl sulfate and ammonium lauryl sulfate; alkylbenzenesulfonates such as sodium dodecylbenzenesulfonate; alkylnaphthalenesulfonates; alkylphosphoric acid ester salts; naphthalenesulfonic acid-formalin condensate; and polyoxyethylene alkyl sulfuric acid ester salts. Additionally, examples of the nonionic surfactants may include: polyoxyethylene alkyl ethers, polyoxyethylene fatty acid esters, sorbitan fatty acid esters, polyoxyethylene alkylamines, glycerin, fatty acid esters and oxyethylene-oxypropylene block polymer. Further, examples of the cationic surfactants may include: alkylamine salts such as laurylamine acetate; and quaternary ammonium salts such as lauryltrimethylammonium chloride and stearyltrimethylammonium chloride. Additionally, examples of the amphoteric surfactants may include aminocarboxylic acid salts and alkylamino acids.

The above-described surfactants can each be used usually in a range from 0.01 to 10% by weight in relation to the polymerizable monomer. The used amount of such a surfactant affects the dispersion stability of the monomer, and also affects the environment dependence of the obtained polymerized toner particle, and hence such a surfactant is preferably used within the above-described range in which the dispersion stability of the monomer is ensured and the environment dependence of the polymerized toner particle is hardly affected in an excessive manner.

For the production of the polymerized toner particle, usually a polymerization initiator is used. Examples of the polymerization initiator include water-soluble polymerization initiators and oil-soluble polymerization initiators. In the present invention, either of a water-soluble polymerization initiator and an oil-soluble polymerization initiator can be used. Examples of the water-soluble polymerization initiator usable in the present invention may include: persulfates such as potassium persulfate and ammonium persulfate; and water-soluble peroxide compounds. Additionally, examples of the oil-soluble polymerization initiator usable in the present invention may include: azo compounds such as azobisisobutyronitrile; and oil-soluble peroxide compounds.

Additionally, for a case where a chain transfer agent is used in the present invention, examples of the chain transfer agent may include: mercaptans such as octylmercaptan, dodecylmercaptan and tert-dodecylmercaptan; and carbon tetrabromide.

Further, for a case where the polymerized toner particle used in the present invention contains a fixability improving agent, examples of the usable fixability improving agent include natural waxes such as carnauba wax and olefin waxes such as polypropylene wax and polyethylene wax.

Additionally, for a case where the polymerized toner particle used in the present invention contains a charge controlling agent, no particular constraint is imposed on the charge controlling agent used, and examples of the usable charge controlling agent include nigrosine dyes, quaternary ammonium salts, organometallic complexes and metal-containing monoazo dyes.

Additionally, examples of the external additives used for improving the fluidity and the like of the polymerized toner particle may include silica, titanium oxide, barium titanate, fluororesin fine particles and acrylic resin fine particles. These external additives can be used each alone or in combinations thereof.

Further, examples of the salting-out agent used for separation of the polymerized particles from the aqueous medium may include metal salts such as magnesium sulfate, aluminum sulfate, barium chloride, magnesium chloride, calcium chloride and sodium chloride.

The average particle size of the toner particle produced as described above falls in a range from 2 to 15 μm and preferably in a range from 3 to 10 μm, and the polymerized toner particle is higher in the particle uniformity than the pulverized toner particle. When the average particle size of the toner particle is smaller than 2 μm, the charging ability is degraded to tend to cause fogging or toner scattering; when larger than 15 μm, such a particle size offers a cause for image quality degradation.

Mixing of the carrier and the toner produced as described above can yield an electrophotographic developer. The mixing ratio between the carrier and the toner, namely, the toner concentration is preferably set at 3 to 15%. When the toner concentration is less than 3%, it is difficult to attain a desired image density; when larger than 15%, toner scattering or fogging tends to occur.

The electrophotographic developer, according to the present invention, prepared as described above can be used in a digital image formation apparatus, such as a copying machine, a printer, a FAX machine or a printing machine, adopting a development method in which an electrostatic latent image formed on a latent image holder having an organic photoconductor layer is reversely developed, while applying a bias electric field, with a magnetic brush of a two-component developer having a toner and a carrier. Additionally, the electrophotographic developer according to the present invention is also applicable to an image formation apparatus, such as a full-color machine, which adopts a method applying an alternating electric field composed of a DC bias and an AC bias superposed on the DC bias when a development bias is applied from the magnetic brush to the electrostatic latent image.

Hereinafter, the present invention is described specifically with reference to Examples and others.

### Example 1

The individual materials were dry mixed in appropriate amounts so as to give the proportions of 39.7 mol % in terms of MnO, 9.9 mol % in terms of MgO, 49.6 mol % in terms of Fe₂O₃ and 0.8 mol % in terms of SrO; the mixture thus obtained was pulverized with a dry vibration mill for 2 hours, and a granulated substance having a size of approximately 2 cm was obtained with a dry granulating machine, and calcined at 950° C. with a rotary kiln furnace to yield a calcined substance. Again, the calcined substance was milled with a wet ball mill for 2 hours to yield a slurry, and the slurry was dried with a spray dryer to be granulated. The granulated substance was maintained at 1300° C. for 3 hours in a nitrogen atmosphere in a tunnel kiln furnace, thereafter disintegrated, and subjected to a particle size distribution regulation to yield a Mn—Mg—Sr ferrite core material having an average particle size of 60 μm. The magnetization of the core material was found to be 75 Am²/kg.

Next, a methylsilicone resin was weighed out in an amount of 100 g in terms of solid content and dissolved in 500 ml of toluene; a fluorine silane coupling agent A represented by the structural formula CF₃CH₂CH₂Si(OCH₃)₃ and having a fluorine ratio of 0.26 was added to the toluene solution thus obtained in an amount of 2.5% by weight in relation to the solid content of the methylsilicone resin to yield a coating solution.

By using a dip coater, 10 kg of the Mn—Mg—Sr ferrite core material was coated with the coating solution. Thereafter, the core material thus coated was baked at 270° C. for 2 hours in a shelved box dryer, then disintegrated and subjected to a particle size regulation to yield an electrophotographic developer carrier. The F/Si value and the F/Fe value of this carrier were measured and found to be 1.6×10⁻³ and 2.4×10⁻⁵, respectively, as shown in Table 1.

The carrier and the magenta toner in a commercially available copying machine, model imagio MP C2500, manufactured by Ricoh Co., Ltd. were weighed out so as to give a toner concentration of 8% by weight and a developer amount of 1 kg. Thereafter, the mixture composed of the carrier and the magenta toner was stirred for 30 minutes to prepare a developer. The charge amount of the developer was measured and found to be 16 μC/g, as shown in Table 2.

Further, the developer was placed in the copying machine, model imagio MP C2500, manufactured by Ricoh Co., Ltd., and was subjected to a 50,000-sheet endurance printing test. The charge amount of the developer after the 50,000-sheet endurance printing was found to be 16 μC/g as shown in Table 2, and almost no decrease of the charge amount was found from the viewpoint of the endurance variation rate of the charge amount. The spent amount and the resin exfoliation amount of the developer after the 50,000-sheet endurance printing were found to be 8% and 3%, respectively, as shown in Table 2, showing that almost no deterioration of the carrier surface was identified. Further, in the evaluation of the image, the toner scattering was extremely low, and the image density was also satisfactory.

Additionally, in a separate evaluation, the change rate of the charge amount rise was found to be 95%, and accordingly, the charge amount rise at the time of feeding of the toner was also found to be satisfactory.

The measurement methods for the spent amount, the resin exfoliation amount, the endurance variation rate of the charge amount and the change rate of the charge amount rise are described below.

### (Spent Amount)

The toner was suction removed from the developer after the endurance printing by using a 635-mesh screen, to extract the carrier after the endurance printing. Thereafter, by using a carbon analyzer, model C-200, manufactured by LECO Co., Ltd. (oxygen gas pressure: 2.5 kg/cm², nitrogen gas pressure: 2.8 kg/cm²), the carbon amount of the carrier and the carbon amount of the carrier after the endurance printing were measured to derive the spent amount from the following formula.

[Spent amount (%)]={[(carbon amount of carrier after endurance printing)−(carbon amount of carrier)]/(carbon amount of carrier)}×100

### (Resin Exfoliation Amount)

The toner was suction removed from the developer after the endurance printing by using a 635-mesh screen, to extract the carrier after the endurance printing. Thereafter, on the basis of a silicon measurement method (JIS G 1212-1997), the silicon amount of the carrier and the silicon amount of the carrier after the endurance printing were measured to derive the resin exfoliation amount from the following formula.

[Resin exfoliation amount (%)]={[(silicon amount of carrier)−(silicon amount of carrier after endurance printing)]/(silicon amount of carrier)}×100

### (Endurance Variation Rate of Charge Amount)

By using the charge amount of the developer after the 30-minute stirring and the charge amount of the developer after the 50,000-sheet endurance printing, the concerned variation rate was derived from the following formula. Here, it is to be noted that the closer to 100% is the endurance variation rate value of the charge amount, the smaller is the endurance variation, the rate value of 100% meaning no endurance variation.

$$[ Endurance variation rate of charge amount ( \% ) ] = \frac{[ \begin{matrix}charge amount of developer of 50 \text{,} 000 - \\ sheet endurance printing\end{matrix} ]}{[ \begin{matrix}charge amount of developer after 30 - \\ minute stirring\end{matrix} ]} \times 100$$

### (Change Rate of the Charge Amount Rise)

The carrier and the magenta toner in a commercially available copying machine, model imagio MP C2500, manufactured by Ricoh Co., Ltd. were weighed out so as to give a toner concentration of 8% by weight and a developer amount of 1 kg. Thereafter, the mixture composed of the carrier and the magenta toner was stirred to obtain a developer after 5-minute stirring. The charge amount of the above-described developer after 30-minute stirring and the charge amount of the developer after 5-minute stirring were measured to derive the change rate of the rise from the following formula. Here, it is to be noted that the closer to 100% is the change rate value of the charge amount rise, the smaller is the change of the rise, the rate value of 100% meaning no change of the rise.

$$[ Change rate of charge amount rise ( \% ) ] = \frac{[ \begin{matrix}charge amount of the developer \\ after 5 - minute stirring\end{matrix} ]}{[ \begin{matrix}charge amount of the developer \\ after 30 - minute stirring\end{matrix} ]} \times 100$$

### (Charge Amount)

The charge amount in each of the evaluations was obtained from the measurement with a suction-type charge amount measurement apparatus, model Epping q/m-meter, manufactured by PES-Laboratorium (mesh: 635 mesh, suction pressure: 105±10 mbar, suction time: 90 seconds).

The toner scattering and the image density were evaluated on the basis of the following standards.

⊚: Excellent, to meet a practical level

◯: Satisfactory, to meet a practical level

Δ: Nearly satisfactory, to meet a practical level

X: Poor, not to meet a practical level

The overall evaluation was conducted on the basis of the following standards.

⊚: Excellent

◯: Good

Δ: Average

X: Poor

For each of following Examples 2 to 11 and Comparative Examples 1 to 5, a coating resin (type, coating amount), a fluorine silane coupling agent (type, fluorine ratio, addition amount) and fluorescent X-ray analysis results are presented in Table 1. By using an electrophotographic developer carrier obtained in each of Examples 2 to 11 and Comparative Examples 1 to 5, in the same manner as in Example 1, different developers (a developer after 30-minute stirring, a developer after 50,000-sheet endurance printing, and a developer after 5-minute stirring) were prepared, and in the same manner as in Example 1, the spent amount, the resin exfoliation amount and the charge amounts (initial value, after 50,000-sheet endurance printing, endurance variation rate, change rate of rise) were measured. Thus, the evaluations of the toner scattering and the image density and the overall evaluation were conducted. The results thus obtained are shown in Table 2.

### Example 2

As shown in Table 1, an electrophotographic developer carrier was prepared in the same steps as in Example 1 except that the addition amount of the fluorine silane coupling agent A was set at 1.0% by weight. The F/Si value and the F/Fe value were measured and found to be 1.5×10⁻³ and 2.4×10⁻⁵, respectively, as shown in Table 1.

### Example 3

As shown in Table 1, an electrophotographic developer carrier was prepared in the same steps as in Example 1 except that as the fluorine silane coupling agent, C₄F₉CH₂CH₂Si(OCH₃)₃ (fluorine ratio=0.46) (fluorine silane coupling agent B) was adopted. The F/Si value and the F/Fe value were measured and found to be 1.7×10⁻³ and 2.8×10⁻⁵, respectively, as shown in Table 1.

### Example 4

As shown in Table 1, an electrophotographic developer carrier was prepared in the same steps as in Example 1 except that as the fluorine silane coupling agent, C₇F₁₅COOCH₂CH₂CH₂Si(OCH₃)₃ (fluorine ratio=0.49) (fluorine silane coupling agent C) was adopted, and the addition amount of the fluorine silane coupling agent C was set at 5.0% by weight. The F/Si value and the F/Fe value were measured and found to be 1.8×10⁻³ and 3.1×10⁻⁵, respectively, as shown in Table 1.

### Example 5

As shown in Table 1, an electrophotographic developer carrier was prepared in the same steps as in Example 1 except that the coating amount of the methylsilicone resin was set at 2.0% by weight, and as the fluorine silane coupling agent, C₆F₁₃CH₂CH₂Si(OCH₃)₃ (fluorine ratio=0.53) (fluorine silane coupling agent D) was adopted, and the addition amount of the fluorine silane coupling agent D was set at 0.8% by weight. The F/Si value and the F/Fe value were measured and found to be 2.0×10⁻³ and 3.2×10⁻⁵, respectively, as shown in Table 1.

### Example 6

As shown in Table 1, an electrophotographic developer carrier was prepared in the same steps as in Example 1 except that the coating amount of the methylsilicone resin was set at 2.5% by weight and the addition amount of the fluorine silane coupling agent A was set at 5.0% by weight. The F/Si value and the F/Fe value were measured and found to be 1.5×10⁻³ and 2.3×10⁻⁵, respectively, as shown in Table 1.

### Example 7

As shown in Table 1, an electrophotographic developer carrier was prepared in the same steps as in Example 1 except that the coating amount of the methylsilicone resin was set at 2.0% by weight. The F/Si value and the F/Fe value were measured and found to be 1.4×10⁻³ and 2.6×10⁻⁵, respectively, as shown in Table 1.

### Example 8

As shown in Table 1, an electrophotographic developer carrier was prepared in the same steps as in Example 1 except that the coating amount of the methylsilicone resin was set at 1.5% by weight and the addition amount of the fluorine silane coupling agent A was set at 6.0% by weight. The F/Si value and the F/Fe value were measured and found to be 1.7×10⁻³ and 2.4×10⁻⁵, respectively, as shown in Table 1.

### Example 9

As shown in Table 1, an electrophotographic developer carrier was prepared in the same steps as in Example 1 except that the coating amount of the methylsilicone resin was set at 2.0% by weight and the addition amount of the fluorine silane coupling agent A was set at 10.0% by weight. The F/Si value and the F/Fe value were measured and found to be 1.9×10⁻³ and 3.0×10⁻⁵, respectively, as shown in Table 1.

### Example 10

As shown in Table 1, an electrophotographic developer carrier was prepared in the same steps as in Example 1 except that the coating amount of the methylsilicone resin was set at 1.5% by weight and the addition amount of the fluorine silane coupling agent A was set at 0.5% by weight. The F/Si value and the F/Fe value were measured and found to be 1.4×10⁻³ and 2.3×10⁻⁵, respectively, as shown in Table 1.

### Example 11

As shown in Table 1, an electrophotographic developer carrier was prepared in the same steps as in Example 1 except that the coating amount of the methylsilicone resin was set at 0.5% by weight and the addition amount of the fluorine silane coupling agent A was set at 15.0% by weight. The F/Si value and the F/Fe value were measured and found to be 2.0×10⁻³ and 3.5×10⁻⁵, respectively, as shown in Table 1.

### Comparative Example 1

As shown in Table 1, an electrophotographic developer carrier was prepared in the same steps as in Example 1 except that no fluorine silane coupling agent was added and the carrier was coated only with the methylsilicone resin. The F/Si value and the F/Fe value were measured and found to be 1.4×10⁻³ and 2.2×10⁻⁵, respectively, as shown in Table 1.

### Comparative Example 2

As shown in Table 1, an electrophotographic developer carrier was prepared in the same steps as in Example 1 except that the coating amount of the methylsilicone resin was set at 2.0% by weight, and as the fluorine silane coupling agent, C₇F₁₅COOCH₂CH₂CH₂Si(OCH₃)₃ (fluorine ratio=0.49) (fluorine silane coupling agent C) was adopted, and the addition amount of the fluorine silane coupling agent C was set at 12.0% by weight. The F/Si value and the F/Fe value were measured and found to be 2.3×10⁻³ and 3.5×10⁻⁵, respectively, as shown in Table 1.

### Comparative Example 3

As shown in Table 1, an electrophotographic developer carrier was prepared in the same steps as in Example 1 except that a fluororesin modified silicone resin was used as the coating resin, and no fluorine silane coupling agent was added. The F/Si value and the F/Fe value were measured and found to be 2.5×10⁻³ and 1.1×10⁻⁴, respectively, as shown in Table 1.

### Comparative Example 4

As shown in Table 1, an electrophotographic developer carrier was prepared in the same steps as in Example 1 except that the coating amount of the methylsilicone resin was set at 2.0% by weight, and as the fluorine silane coupling agent, C₆F₁₃CH₂CH₂Si(OCH₃)₃ (fluorine ratio=0.53) (fluorine silane coupling agent D) was adopted, and the addition amount of the fluorine silane coupling agent D was set at 5.0% by weight. The F/Si value and the F/Fe value were measured and found to be 2.1×10⁻³ and 3.6×10⁻⁵, respectively, as shown in Table 1.

### Comparative Example 5

As shown in Table 1, an electrophotographic developer carrier was prepared in the same steps as in Example 1 except that the coating amount of the methylsilicone resin was set at 2.0% by weight, and as the fluorine silane coupling agent, C₈F₁₇CH₂CH₂SiCH₃(OCH₃)₂ (fluorine ratio=0.59) (fluorine silane coupling agent E) was adopted, and the addition amount of the fluorine silane coupling agent E was set at 5.0% by weight. The F/Si value and the F/Fe value were measured and found to be 2.5×10⁻³ and 3.8×10⁻⁵, respectively, as shown in Table 1.

TABLE 1

| | Coating resin | | Fluorine silane coupling agent | | | | |
|---|---|---|---|---|---|---|---|
| | | Coating | | | Addition | | |
| | | amount | | Fluorine | amount | Fluorescent X-ray analysis | |
| | Type | (wt %) | Type | ratio | (wt %) | F/Si | F/Fe |
| Ex. 1 | Methylsilicone resin | 1.0 | A | 0.26 | 2.5 | 1.6 × 10⁻³ | 2.4 × 10⁻⁵ |
| Ex. 2 | Methylsilicone resin | 1.0 | A | 0.26 | 1.0 | 1.5 × 10⁻³ | 2.4 × 10⁻⁵ |
| Ex. 3 | Methylsilicone resin | 1.0 | B | 0.46 | 2.5 | 1.7 × 10⁻³ | 2.8 × 10⁻⁵ |
| Ex. 4 | Methylsilicone resin | 1.0 | C | 0.49 | 5.0 | 1.8 × 10⁻³ | 3.1 × 10⁻⁵ |
| Ex. 5 | Methylsilicone resin | 2.0 | D | 0.53 | 0.8 | 2.0 × 10⁻³ | 3.2 × 10⁻⁵ |
| Ex. 6 | Methylsilicone resin | 2.5 | A | 0.26 | 5.0 | 1.5 × 10⁻³ | 2.3 × 10⁻⁵ |
| Ex. 7 | Methylsilicone resin | 2.0 | A | 0.26 | 2.5 | 1.4 × 10⁻³ | 2.6 × 10⁻⁵ |
| Ex. 8 | Methylsilicone resin | 1.5 | A | 0.26 | 6.0 | 1.7 × 10⁻³ | 2.4 × 10⁻⁵ |
| Ex. 9 | Methylsilicone resin | 2.0 | A | 0.26 | 10.0 | 1.9 × 10⁻³ | 3.0 × 10⁻⁵ |
| Ex. 10 | Methylsilicone resin | 1.5 | A | 0.26 | 0.5 | 1.4 × 10⁻³ | 2.3 × 10⁻⁵ |
| Ex. 11 | Methylsilicone resin | 0.5 | A | 0.26 | 15.0 | 2.0 × 10⁻³ | 3.5 × 10^{-s} |
| Com. | Methylsilicone resin | 1.0 | — | — | — | 1.4 × 10⁻³ | 2.2 × 10⁻⁵ |
| Ex. 1 | | | | | | | |
| Com. | Methylsilicone resin | 2.0 | C | 0.49 | 12.0 | 2.3 × 10⁻³ | 3.5 × 10⁻⁵ |
| Ex. 2 | | | | | | | |
| Com. | Fluororesin modified | 2.0 | — | — | — | 2.5 × 10⁻³ | 1.1 × 10⁻⁴ |
| Ex. 3 | silicone resin | | | | | | |
| Com. | Methylsilicone resin | 2.0 | D | 0.53 | 5.0 | 2.1 × 10⁻³ | 3.6 × 10⁻⁵ |
| Ex. 4 | | | | | | | |
| Com. | Methylsilicone resin | 2.0 | E | 0.59 | 5.0 | 2.5 × 10⁻³ | 3.8 × 10⁻⁵ |
| Ex. 5 | | | | | | | |

TABLE 2

| | | | Charge amount | | | | | | |
|---|---|---|---|---|---|---|---|---|---|
| | | | | After | | | | | |
| | | Resin | | 50,000-sheet | Endurance | Change | | | |
| | Spent | exfoliation | | endurance | variation | rate of | | | |
| | amount | amount | Initial | printing | rate | rise | Toner | Image | Overall |
| | (%) | (%) | (μC/g) | (μC/g) | (%) | (%) | scattering | density | evaluation |
| Ex. 1 | 31 | 11 | 16 | 16 | 100 | 95 | ⊚ | ⊚ | ⊚ |
| Ex. 2 | 42 | 4 | 17 | 17 | 100 | 92 | ⊚ | ⊚ | ⊚ |
| Ex. 3 | 31 | 11 | 18 | 17 | 94 | 85 | ⊚ | ⊚ | ⊚ |
| Ex. 4 | 38 | 18 | 19 | 18 | 95 | 82 | ⊚ | ◯ | ◯ |
| Ex. 5 | 46 | 49 | 20 | 19 | 95 | 80 | ◯ | Δ | Δ |
| Ex. 6 | 65 | 28 | 15 | 11 | 83 | 92 | ◯ | ⊚ | ◯ |
| Ex. 7 | 38 | 18 | 11 | 8 | 83 | 94 | Δ | ⊚ | ◯ |
| Ex. 8 | 42 | 21 | 18 | 16 | 90 | 85 | ⊚ | ⊚ | ⊚ |
| Ex. 9 | 38 | 28 | 19 | 18 | 95 | 85 | ⊚ | ⊚ | ⊚ |
| Ex. 10 | 54 | 31 | 12 | 8 | 87 | 94 | Δ | ◯ | Δ |
| Ex. 11 | 31 | 35 | 22 | 20 | 91 | 81 | ◯ | Δ | Δ |
| Com. | 270 | 4 | 10 | 5 | 50 | 93 | X | Δ | X |
| Ex. 1 | | | | | | | | | |
| Com. | 46 | 18 | 23 | 19 | 83 | 75 | ◯ | X | X |
| Ex. 2 | | | | | | | | | |
| Com. | 77 | 62 | 27 | 24 | 89 | 72 | ◯ | X | X |
| Ex. 3 | | | | | | | | | |
| Com. | 54 | 52 | 22 | 20 | 91 | 78 | ◯ | X | X |
| Ex. 4 | | | | | | | | | |
| Com. | 46 | 69 | 26 | 19 | 73 | 72 | Δ | X | X |
| Ex. 5 | | | | | | | | | |

As is clearly seen from the results shown in Table 2, in each of Examples 1 to 11, when each of Examples 1 to 11 is used as a developer, the spent amount and the resin exfoliation amount are each small, the endurance variation rate value of the charge amount and the change rate value of the charge amount rise are each at a high level, and the endurance variation of the charge amount and the change of the charge amount rise are each small. Additionally, in each of Examples 1 to 11, the results obtained for the toner scattering and the image density are excellent.

On the contrary, in Comparative Example 1, the spent amount is large and the endurance variation rate value of the charge amount is small, and hence the endurance variation is large and the toner scattering is evaluated as poor. In Comparative Example 2, the change rate value of the charge amount rise is small, and hence the change of the charge amount rise is large and the image density is poor. In Comparative Example 3, the spent amount and the resin exfoliation amount are each large, and the change rate value of the charge amount rise is small, and hence the change of the charge amount rise is large and the image density is poor. In Comparative Example 4, the resin exfoliation amount is large and the change rate value of the charge amount rise is small, and hence the change of the charge amount rise is large and the image density is poor. In Comparative Example 5, the resin exfoliation amount is large, and the endurance variation rate value of the charge amount and the change rate value of the charge amount rise are each small, and hence the endurance variation and the change of the charge amount rise are each large and the image density is poor.

In the electrophotographic developer using the electrophotographic developer carrier according to the present invention, even in a long term use, the occurrence of the spent condition is prevented, the degradation of the charge amount is small, the durability is excellent, the toner scattering is low and the image density is satisfactory.

Consequently, the electrophotographic developer carrier according to the present invention and the electrophotographic developer using the carrier can be widely used in the fields associated with full-color machines required to be high in image quality and high speed machines required to be satisfactory in the reliability and durability in the image maintenance.

1. An electrophotographic developer carrier that comprises on the surface of a carrier core material a coating resin comprising a silicone resin containing a fluorine silane coupling agent, has an intensity ratio (F/Si), measured with fluorescent X-ray, between the fluorine atom and the silicon atom present on the carrier surface of 1.4×10⁻³ to 2.0×10⁻³, and has an intensity ratio (F/Fe), measured with fluorescent X-ray, between the fluorine atom and the iron atom present on the carrier surface of 2.3×10⁻⁵ to 3.5×10⁻⁵.

2. The electrophotographic developer carrier according to claim 1, wherein the fluorine ratio represented by the molecular weight of the fluorine in the fluorine silane coupling agent/the molecular weight of the fluorine silane coupling agent is 0.49 or less.

3. The electrophotographic developer carrier according to claim 1, wherein the content of the fluorine silane coupling agent in the coating resin in relation to the coating resin amount is 0.8 to 12.0% by weight.

4. An electrophotographic developer comprising the carrier according to claim 1 and a toner.

5. An electrophotographic developer comprising the carrier according to claim 2 and a toner.

6. An electrophotographic developer comprising the carrier according to claim 3 and a toner.
